(19) United States
(12) Patent Application Publication
(10) Pub. No.: US 2014/0214509 A1
(43) Pub. Date: Jul. 31, 2014

(54) SYSTEM AND METHOD OF EFFECTING A MERCHANT FUNDED REWARD

(71) Applicant: Independent Transaction Solutions PTY LTD, Melbourne (AU)

(72) Inventors: Paul Adrian Lee, Toorak (AU); Christian Felix Strauss, East Malvern (AU); Ian McKenzie, South Yarra (AU); David Shane Que, Camberwell (AU); Matthew John Weir, Singapore (SG); Theodora Keramidas, Glen Iris (AU); Simon Paul Sorockyj, Ivanhoe (AU)

(21) Appl. No.: 14/012,828

(22) Filed: Aug. 28, 2013

Related U.S. Application Data
(63) Continuation of application No. PCT/AU2012/000031, filed on Jan. 17, 2012.

(30) Foreign Application Priority Data
Jan. 17, 2011 (AU) 2011900138

(51) Int. Cl. G06Q 30/02

(52) U.S. Cl. CPC G06Q 30/0215
USPC 705/14.17

(57) ABSTRACT

A computer implemented method of effecting a merchant funded reward when a consumer purchases goods and/or services from a merchant using an electronic payment, including a processor executing instruction code causing collection of transaction details of the consumer purchase, processing of the transaction details to calculate any associated reward, and notification of the entire reward to be collected from the merchant.

### CROSS-REFERENCE TO PRIORITY APPLICATIONS

This application is a continuation of International Application No. PCT/AU2012/000031 for a System and Method of Effecting a Merchant Funded Reward (filed Jan. 17, 2012, and published Jul. 26, 2012, as International Publication No. WO 2012/097404), which itself claims priority to Australian Application No. 2011900138 for a System and Method of Effecting Merchant Funded Rewards (filed Jan. 17, 2011) and also to U.S. patent application Ser. No. 61/440,240 for a System and Method of Effecting a Merchant Funded Reward (filed Feb. 7, 2011). Each of the foregoing patent applications and patent publication is hereby incorporated by reference in its entirety.

### FIELD OF THE INVENTION

The invention relates generally to a system, method and computer instruction code for effecting a merchant funded reward.

### BACKGROUND OF THE INVENTION

Reward programs have been known for many years and were initially devised and operated by merchants seeking to attract consumers and establish consumer loyalty and repeat purchases in relation to the goods and/or services offered by the merchant. In an attempt to establish consumer loyalty, merchants will frequently offer a reward to consumers who make repeat purchases or purchase goods and/or services in significant volume. Rewards offered by merchants to consumers for their loyalty generally include discounts, reward points or vouchers (that may be used to effect future purchases with the merchant) or cash rebates.

Further, merchants operating their own reward programs, or third parties who establish arrangements with a number of merchants and offer rewards on their collective behalf to consumers, generally issue a non-electronic membership card or electronic card with limited functionality (sometimes referred to as Flash Cards or Dumb Cards). These cards are limited in their use and where they embody electronic functionality, they generally require specifically configured terminals at the merchant premises to enable their use. In the instance of a third party acting on behalf of a number of merchants for the purpose of offering rewards, the rewards are generally funded by the merchant.

With the introduction of credit, debit and pre-paid cards, consumers increasingly sought to purchase goods and/or services from merchants using such cards. Of these cards representing different payment arrangements, credit cards were the first to be introduced on a mass scale and provided consumers with a line of credit.

In some instances, organizations established operations that directly provided the consumer with credit (eg American Express and Diners Club) and hence the organisation incurred the credit risk. According to this model, the organization issues consumers with cards directly and hence this arrangement is referred to as a “direct issuance model”.

In other instances, organizations (eg VISA and MasterCard) established relationships with existing financial institutions that manage credit risk as part of their usual operations. In this model, credit cards are issued to consumers by the financial institutions and not by the organization that operates the credit card network and hence, this arrangement is referred to as an “in-direct issuance model”.

In either model, the card issued to the consumer is referred to as a credit card as purchases are effectively allowed or denied according to the rules associated with the consumer's line of credit irrespective of which entity affords credit to the consumer.

Initially, credit cards according to the in-direct model were controlled by the issuing financial institution and contractual arrangements were established between the various financial institutions that were issuing credit cards. Eventually, separate entities such as Visa and MasterCard were established and these entities operate the networks that transmit the transactions between acquiring and issuing financial institutions. However, irrespective of the issuance model, the organizations responsible for the credit cards are referred to as Network Operators.

According to the in-direct issuance model, the financial institution issues a card to a consumer and when the consumer uses the credit card to purchase goods and/or services from a merchant, the transaction details are initially passed to the merchant's financial institution and subsequently communicated to the consumer's credit card issuing financial institution across an Electronic Payment Network. During this “credit transaction”, a fee is levied upon the merchant (referred to as the Merchant Service Fee or MSF) and the financial institution that issues the credit card to the consumer receives a handling fee (referred to as the Interchange Fee or ICF) which is a percentage of the MSF.

Credit cards became very popular after they were initially introduced to the consumer market and rewards were offered by credit providers to consumers to encourage consumers to make purchases.

Irrespective of the issuance model or the particular fee model, it is the collection of fees during credit transactions that have substantially enabled the funding of rewards. Over time, the rewards offered by the Network Operators have become a distinguishing aspect and are used in marketing campaigns to attract new consumers to enter into a credit agreement with an issuing financial institution or directly with a Network Operator such as Amex or Diners Club.

Subsequent to the introduction of credit cards, debit and pre-paid cards were issued by some financial institutions and Network Operators to accommodate a specific consumer demand in the market.

More recently, debit and pre-paid arrangements have become the preferred type of payment arrangement for many consumers and there is a substantial reduction in the number of consumers using credit. The initial motivation in this regard was the increasing number of consumers seeking to purchase items from the internet and in these instances, consumers preferred to use a payment arrangement other than a line of credit to reduce the liability for any fraudulent use of their account. Subsequently, since the economic downturn of recent times, consumers have displayed an increasing tendency to prefer debit and/or pre-paid electronic payments for purchases from all merchants in addition to on-line merchants.

Purchases effected with Debit and/or Pre-paid cards access the consumer's funds directly and do not require a line of credit. This is particularly useful for consumers who have difficulty obtaining the necessary credit for a credit card or, who prefer to avoid the prospect of incurring debt when purchasing goods and/or services from merchants. In the event that a consumer seeks to effect a purchase with a Debit or Pre-paid card and they do not have sufficient funds for the transaction, the purchase request is denied.

The increasing popularity of debit and pre-paid cards presents a problem for Network Operators who, in most instances, have become reliant upon the fees generated by credit transactions to fund rewards to consumers. In this regard, no fees are collected by such network operators for debit or pre-paid transactions when they are processed across the payment networks that usually effect these types of transactions.

Accordingly, Network Operators need to consider alternative funding arrangements for rewards in view of changing consumer behaviour and the impact that changing behaviour can have in relation to the collection of fees and hence the funding of rewards.

Therefore, merchant funded rewards delivered to debit prepaid cards over EPN is the solution to this problem

### SUMMARY OF THE INVENTION

In one aspect, the present invention provides a computer implemented method of effecting a merchant funded reward when a consumer purchases goods and/or services from a merchant using an electronic payment, including, a processor executing instruction code causing, collection of transaction details of the consumer purchase, processing of the transaction details to calculate any associated reward, and notification of the entire reward to be collected from the merchant.

In one embodiment, the entire consumer reward collected from the merchant is provided to the consumer. In other embodiments, part of the reward collected from the merchant is provided to the consumer.

In an embodiment, the electronic payment accesses a consumer's line of credit to settle the transaction. In another embodiment, the electronic payment accesses a consumer's funds to settle the transaction, generally as a result of the consumer using a debit or pre-paid electronic payment. The electronic payment may be effected by the use of a card, such as a credit, debit or pre-paid card. However, electronic payments may also be made using on-line services provided by web-sites or mobile phone (cell phone) software applications that access the relevant consumer account without requiring the use of a physical card.

In an embodiment, collection of the transaction details of the consumer purchase is effected by an interface to an Electronic Payments Network over which transactions relating to electronic payments for purchases are transmitted.

In this regard, Electronic Payment Networks can be either “open loop” networks or “closed loop” networks. In the case of an “open loop” network, the provider of the network allows any terminal equipment to communicate transactions over the network and the contractual arrangements between the various entities are greatly simplified. On the basis that the terminal equipment abides by the technical requirements for effective communication of transactions over the network, the network provider allows the transaction to be communicated across the network. This allows merchants to avail themselves of the “open loop” network without requiring the merchant to reconfigure or alter their transaction terminal equipment in order to communicate transactions over the network. In contrast, “closed loop” networks only allow specific participants to communicate transactions across the network and this also generally requires the merchant to purchase specific terminal equipment or re-configure their existing terminal equipment to effect communications across the network and avail themselves of communication over the “closed loop” network. Further, the contractual arrangements required between the various entities is significantly more complex as compared with “open loop” network arrangements. For example, in a “closed loop” network, it is necessary to establish direct contractual arrangements between acquiring financial institutions and issuing financial institutions that may participate in transactions across the network.

In one embodiment, an electronic payments network is an “open loop” network. This type of network is operated by Visa and MasterCard. Additionally, the network (either open or closed loop) may extend across national borders and may form a global network, or part thereof.

In an embodiment, the electronic payment relates to a Network Operator that has an in-direct issuance model with respect to issuance of credit cards.

In one particular embodiment, merchants and consumers associated with a merchant funded reward program are registered and relevant details are recorded in a database. Monitoring transaction details as they are transmitted across an Electronic Payments Network, and comparison of same with the recorded details of merchants and consumers in the database, enables transactions relating to participating merchants and consumers to be identified and recorded by an independent processing system.

When a transaction involving a registered merchant and consumer is identified, a copy of the transaction details may be recorded and passed to an independent processing system that calculates and establishes the appropriate consumer reward, if any, applicable to the transaction. Advantageously, the transaction transmitted across the Electronic Payments Network is not interrupted, diverted or delayed, and as a result, the transmitted transaction is not affected in any way. As a result, the usual means by which consumers conduct transactions with merchants to purchase goods and/or services remain applicable to the present invention. For example, consumers, may purchase goods and/or services from merchants by use of POS (Point of Sale) terminals, use of an on-line service such as a payment gateway associated with a web-site or by use of a mobile phone/Smart Phone/PDA (Personal Digital Assistant) software application. As long as the details of a purchase request are transmitted over the Electronic Payments Network, it does not make any difference how the transaction is conducted between the consumer and the merchant. This should enable continued relevance of the invention despite future technological developments in relation to the interface between consumers and merchants and consumers and their issuing banks (in the case of an in-direct issuance model). Further, the present invention enables Network Operators to effect merchant funded rewards with no requirement for any modification to the existing installed infrastructure for effecting electronic payments between consumers and merchants irrespective of the underlying type of network (eg open loop or closed loop).

An additional benefit is the avoidance of any training requirement for staff or any requirement to modify merchant operations or procedures whilst ensuring that rewards offered by the merchant are notified for collection.

In an embodiment, when a transaction involving a participating merchant and consumer is identified and captured from an Electronic Payments Network and passed to an independent processing system, the independent processing system calculates the consumer reward based upon predefined rules. The rules may include a range of details pertaining to the consumer reward relevant to the transaction and may include details such as the type and amount of the reward offered by the merchant, the time and dates for which the offered reward is valid, the specific location of the merchant offering the reward and any other details relevant to calculating the reward that is to be collected from the merchant.

In an embodiment, the consumer reward offered by merchants is a cash rebate and subsequent to calculating the specific cash rebate to be notified, the method includes the step of collecting the appropriate amount of cash from the merchant offering the reward and depositing the cash collected from the merchant into the account of an independent processor. In one embodiment, the entire cash reward collected from the merchant is deposited into a consumer's cash account. In other embodiments, part of the cash reward collected from the merchant is deposited into a consumer's cash account. In any event, once the cash reward, or part thereof, is deposited into the consumer's cash account, the consumer may then access the cash reward directly from their cash account. In one particular embodiment, the method also includes the step of the processor executing instruction code to cause a notification to be sent to the consumer advising that a cash rebate has been deposited into their nominated cash account thus confirming availability for withdrawal and/or use of the cash in further transactions.

In another embodiment, the cash rebate that is deposited into a consumer's account is accessed by the consumer and used to purchase additional goods and services for which another cash rebate is obtained in respect of the additional purchased goods and/or services.

In another aspect, the present invention provides a system for effecting merchant funded rewards for purchases of goods and/or services from merchants offering rewards where the consumer effects an electronic payment, including an interface module operably connected to an Electronic Payments Network executing computer instruction code that causes the monitoring of purchase transactions, a processing module executing computer instruction code that causes the identification of relevant monitored purchase transactions and calculating the rewards, if any, relevant to the transactions, and a communication module executing computer instruction code that causes the transmission of details of the entire calculated reward to be collected from the relevant merchant.

In one particular embodiment, an Electronic Payments Network only transmits and receives transactions pertaining to credit transactions. Although the network is operable to process debit and pre-paid transactions, it is not used for these types of transaction. Accordingly, the fees levied upon parties as a result of transactions processed by this network are only those fees that are applicable to credit transactions. In this embodiment, the actual network over which transactions will be processed are determined by the consumer's selection of a payment method when operating a POS terminal. For example, when seeking to effect a purchase with either a debit or pre-paid card, the consumer selects a payment method of “savings” or “cheque” on the POS terminal and the transaction is directed to a network that processes these types of transactions. However, when seeking to effect a purchase using credit, the consumer selects the “credit” function on the POS terminal and the transaction is directed to an Electronic Payments Network that processes credit transactions. In this embodiment, consumers can be encouraged to select the “credit” function on the POS terminal to collect a merchant reward associated with their purchase although they seek to effect a debit or pre-paid purchase and have only provided details of their debit or pre-paid account.

In this embodiment, it then only becomes necessary to establish system components on a single network for the purpose of monitoring transactions and identifying and notifying rewards to be collected. The consumer purchase is settled by withdrawal of funds from the consumer account associated with the debit or pre-paid card but the processing of the transaction over the Electronic Payments Network that usually only processes credit transactions effectively allows the consumer to elect to receive the reward offered by the merchant. In this embodiment, the Network Operator who provides the network service advantageously collects fees usually associated only with a credit transaction (although potentially at a different rate) despite the transaction being a debit or pre-paid transaction.

In another aspect, the present invention provides computer readable storage media including modules having computer instruction code recorded thereon, the computer instruction code executing the steps of effecting a merchant funded reward.

The computer instruction code may result in computer instructions that are implemented integrally to a computer over a network using separate software components. The computer instruction code may also include components of existing software that effects functions in cooperation with dedicated code developed specifically for the present invention.

### BRIEF DESCRIPTION OF THE DRAWINGS

An embodiment of the invention will now be described which should not be considered as limiting any of the statements in the previous section. The embodiment will be described with reference to the following figures in which:

FIG. 1 is a diagrammatic representation of the entities involved in a consumer effecting an electronic purchase with a merchant where the consumer uses a credit card of a Network Operator having an in-direct issuance model, in a first embodiment of a merchant funded reward according to the present invention;

FIG. 2 is a diagrammatic representation of a second embodiment of a merchant funded reward according to the present invention;

FIG. 3 is a diagrammatic representation of a third embodiment of a merchant funded reward according to the present invention; and

FIG. 4 is a diagrammatic representation of a fourth embodiment of a merchant funded reward according to the present invention.

### DETAILED DESCRIPTION OF EMBODIMENTS OF THE INVENTION

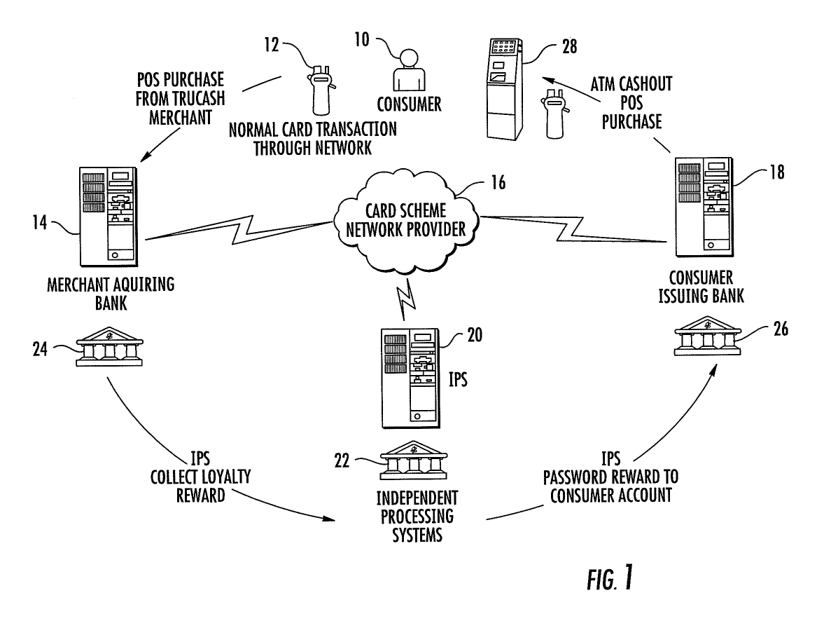

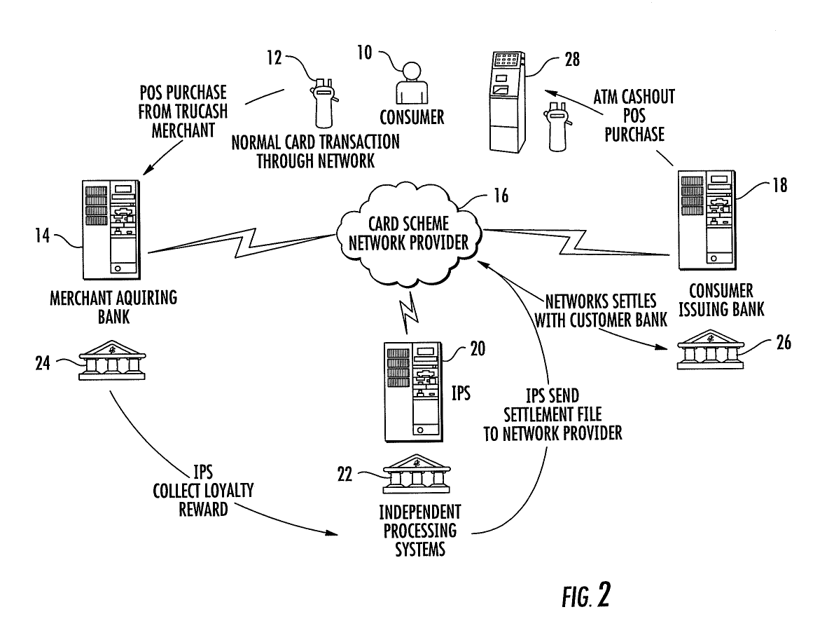

With reference to FIG. 1, a diagrammatic representation of an electronic transaction between a consumer and a merchant is provided wherein the consumer uses an electronic payment to settle the transaction that is associated with a Network Operator having an in-direct issuance model. FIG. 1 details the various the entities involved in the transaction which in the instance of FIG. 1 is effected over an open loop network. Although the type of transaction is not specifically identified, the embodiment is equally applicable to the purchase request being a credit purchase or a purchase using a Debit or Pre-paid card.

Where the entities of FIG. 1 are detailed and described in further embodiments represented in FIGS. 2, 3 and 4, like numerals are used to identify those entities. Further, there are various references to “banks” and/or “bank accounts” in the description of the embodiments and it will be recognised by those skilled in the relevant field of technology that references to such institutions and accounts equally apply to other types of financial institutions such as credit unions. In its broadest form, any institution that qualifies as an ADI (Approved Deposit taking Institution) that can receive and provide funds for and on behalf of third parties, qualifies in place of a bank as described below.

Referring to FIG. 1, a consumer (10) seeking to purchase goods and/or services from a merchant commences a purchase request with the merchant using an electronic payment card, thus causing an electronic payment request to purchase goods and/or services. The merchant processes the purchase request of the consumer (10) by use of a Point of Sale transaction terminal (12) which is operably connected to a merchant acquiring bank server (14). The merchant acquiring bank server (14) transmits the consumer's purchase request and all relevant details pertaining thereto, across an Electronic Payments Network. The Electronic Payments Network (16) transmits the consumer's purchase request from the merchant acquiring bank server (14) to the consumer issuing bank transaction server (18). The transaction server (18) determines whether the consumer (10) has sufficient funds and/or available credit to purchase the goods and/or services from the merchant and in the event that the consumer (10) has sufficient funds and/or available credit, the transaction server (18) transmits an approval for the purchase request to the merchant acquiring bank server (14) across the Electronic Payments Network (16).

Upon receipt of a purchase request approval by the merchant acquiring bank server (14), the merchant provides the goods and/or services to the consumer (10) in the knowledge that they will receive funds from the consumer's issuing bank (26) that is effected in a subsequent settlement function for which a message is transmitted to the merchant advising same.

In the instance of a merchant funded reward, an independent processing server (20) monitors transaction requests and approvals, or denial thereof, as they are transmitted across the Electronic Payments Network (16). The independent processing server (20) is operably connected to a database (not detailed) that contains details of all participating merchants and consumers in the merchant funded consumer reward program.

In an embodiment, the transaction includes details such as the Merchant Identification (MID), the Acquirer Identification (AID), the Bank Identification Number (BIN) and the account number of the consumer.

By monitoring the transactions transmitted across the Electronic Payments Network (16), the independent processing server (20) can identify transactions relevant to the merchant funded reward program offered by participating merchants to consumers upon receipt of a settlement message regarding a transaction. Having identified a relevant transaction involving a participating merchant and consumer, the independent processing server (20) executes computer instruction code to calculate the relevant reward, if any, offered by the merchant for which notification and collection of the entire reward from the merchant is required.

In one embodiment, the reward offered by merchants to consumers is a cash rebate that may have various conditions associated with the reward offer. For example, the reward may only be offered by merchants in certain locations or for transactions effected within a specific time period and/or specific goods and/or services offered by the merchant. In any event, the independent processing server (20) includes a database of all merchant offered rewards relevant to the merchant funded reward program and any conditions associated therewith. For each transaction identified from the Electronic Payments Network (16) as involving participating merchants and consumers, the transactions details may be compared with the database of all merchant reward offers to determine those transactions for which a reward is to be collected from the merchant in its entirety.

Having identified a transaction for which a merchant reward has been offered, the independent processing server (20) calculates the details of the reward and these details are passed to the independent processing system bank (22). Details pertaining to transactions for which the entire rewards are to be collected from a merchant may be passed from the independent processing server (20) to the independent processing system bank (22) in real time as they are identified and calculated, or at regular intervals in a batch process.

In the instance of the embodiment of FIG. 1, the entire reward collected from the merchant is provided to the consumer. Accordingly, the independent processing system bank (22) effects a transfer of funds from the merchant bank (24) to the relevant consumer issuing bank (26) according to the reward offered by the merchant to the consumer. Receipt of funds by the consumer issuing bank (26) is processed by the issuing bank transaction server (18) and subsequent to receipt of funds in accordance with the reward offered by the merchant, the consumer (10) may access those funds from their issuing bank (26) by any of the usual means including access from an automatic teller machine (ATM) (28) or on-line etc. It shall be noted that the settlement to the issuing bank does not need to be the same independent bank that transferred it from the merchant bank.

In an embodiment, the consumer (10) is notified of the deposit of cash into their cash account as a reward from the merchant. Of course, in the event that the transactions are effected quickly, consumers may receive notification of the deposit of a cash reward from a merchant whilst they are within the vicinity of the merchant premises. For example, where notifications are sent by SMS (Short Message Service) or similar services operated by telecommunications service providers, the consumer may receive an SMS notification on their mobile phone (sometimes referred to as a cell phone of hand phone) confirming the deposit of a merchant cash reward. Of course, the notification could be by email or any other form of communication, but preferably electronic. This may encourage the consumer to make further purchases or at least may provide the consumer with assurance that they have received the reward they were expecting from the merchant. In any event, the consumer has an enhanced experience when transacting with the merchant when using an electronic payment to settle purchases of goods and/or services. Further, collection of the entire reward from the merchant provides a source of funding for rewards that does not rely upon relatively high fees levied upon various entities as a result of performing various parts of the transaction.

In the instance of the embodiment detailed in FIG. 2, whilst the entities each operate in the same manner substantially as described in the embodiment of FIG. 1, the independent processing system bank (22) transmits a settlement file to the Network Operator who operates the Electronic Payments Network (not detailed) and who subsequently deposits funds into consumer's cash accounts in accordance with the reward collected from merchants.

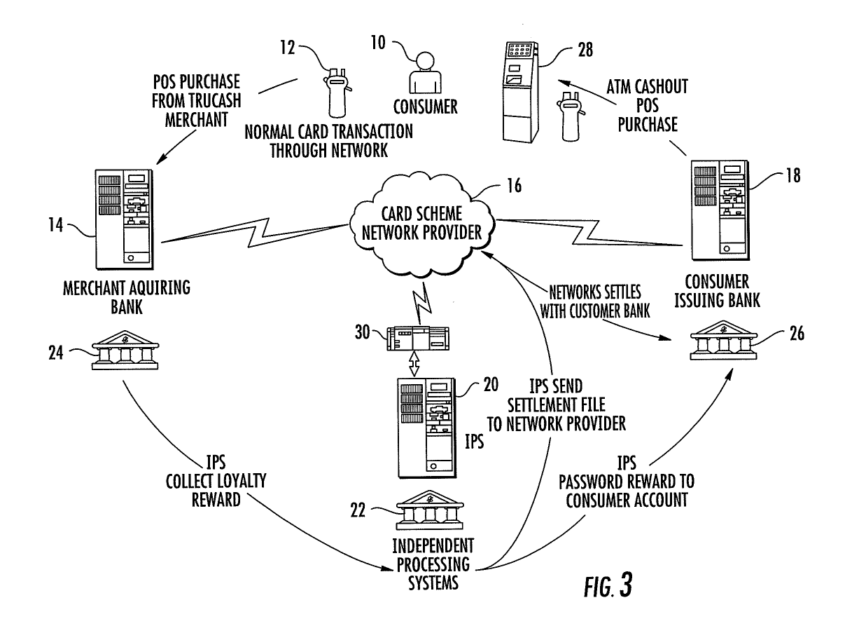

With reference to FIG. 3, another embodiment of a merchant funded consumer reward program is illustrated wherein the Network Operator processing server (30) monitors transactions transmitted across the Electronic Payments Network (16).

The Network Operator processing server (30) is operably connected to a database that contains details of all participating merchants and consumers in the merchant funded consumer reward program. By monitoring the transactions transmitted across the Electronic Payments network (16) the Network Operator processing server (30) can identify transactions relevant to the merchant funded reward program offered by participating merchants to consumers upon settlement of a transaction by use of an electronic payment card. Having identified a relevant transaction involving a participating merchant and consumer, the transaction (and/or details thereof) is transmitted from the Network Operator processing server (30) to the independent processing server (20). The independent processing server (20) calculates the reward, if any, offered by the merchant for which collection from the merchant and subsequent transfer to the consumer is required. In the embodiment of FIG. 3, the independent processing server is also detailed providing rewards to the consumer cash account at the consumer issuing bank which represents an equally applicable alternative arrangement. Of course, it is not necessary for the independent processing server to calculate the reward and this component of the method may be effected externally by another system in communication with the independent processing server.

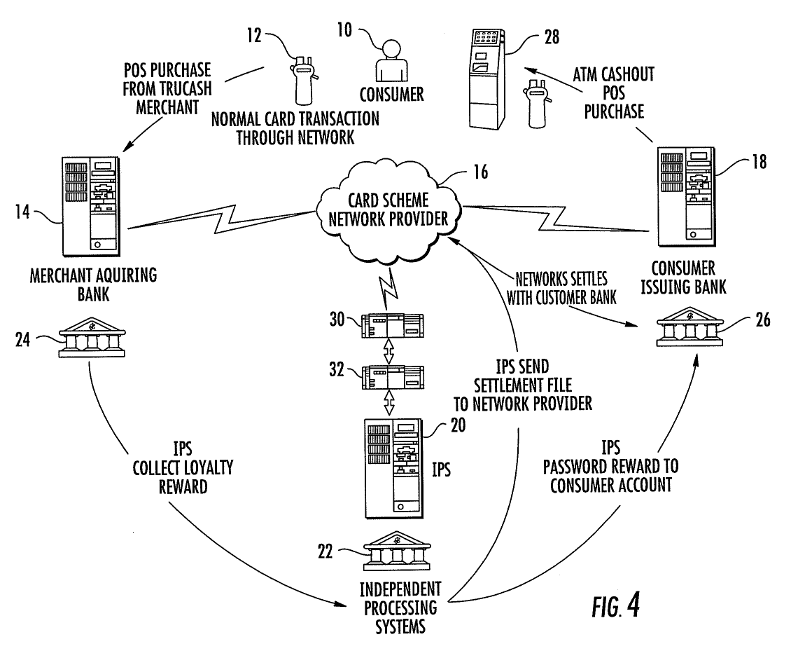

With reference to FIG. 4, the embodiment detailed therein includes a Network Operator processing server (30) as detailed in FIG. 3. However, in the embodiment of FIG. 4, having identified relevant transactions involving participating merchants and consumers, the Network Operator processing server (30) transmits the transaction (and/or details thereof) to a third party processor (32).

The third party processor (32) may transmit the transactions (and/or details thereof) to the independent processing server (20) in real time or may batch the relevant transactions and transmit them at a later time by batch file. Similarly, as detailed in FIG. 3, the independent processing server is also detailed providing rewards to the consumer cash account at the consumer issuing bank which represents an equally applicable alternative arrangement.

Although collection of transaction details pertaining to consumer purchases from the Electronic Payments Network through an interface to the Network Operator is convenient, in another embodiment the transaction details are collected from the consumer issuing banks. In this embodiment, a commercial arrangement would need to be established with all issuing banks that prefer to participate in the merchant funded consumer rewards program and whilst this is a less convenient arrangement, it remains a technically and commercially feasible embodiment of the invention.

Merchant funded consumer rewards according to the present invention enable merchant rewards to be offered in respect of consumer payments effected using an electronic payment arrangement which enables Network Operators to adopt an alternative funding arrangement for such rewards. Further, the system may be implemented without requiring any changes to the existing installed infrastructure at merchant premises (or merchant on-line purchasing operations) and also avoids the need to conduct any merchant (or other) staff training to ensure that appropriate rewards are collected from the merchant in accordance with an offer. In one particular embodiment, when the consumer seeks to effect a transaction using a debit or pre-paid card, selection of the POS terminal function “savings” or “cheque” can continue to be selected for consumers seeking to access funds directly from an account to settle the transaction without obtaining a reward from the merchant. However, for consumers who prefer to receive a reward, although the card swiped through the terminal may be a debit or pre-paid card, they can select the “credit” function in the POS terminal when selecting the payment option and this may be interpreted by the independent processing server as the consumer electing to receive a reward offered by the merchant.

In instances where the Electronic Payments Network extends across borders, and the Network Operator operates across borders, merchant funded rewards may be effected across borders and hence, a consumer who travels to another country may take advantage of merchant funded rewards offered by a merchant in a country other than their home country (ie the country of their issuing bank). This allows aggregation of merchants and consumers across borders participating in the merchant funded rewards. Similarly, the present invention enables the aggregation of issuing banks across borders within a merchant funded reward arrangement.

Embodiments of the invention enable a high level of measurement and feedback to merchants regarding the success of the rewards they offer to consumers in relation to repeat visits and purchases from the merchant by consumers. As consumers effect payments electronically, the data pertaining to those payments and the rewards collected from merchants may be used for a range of purposes and enable data mining to determine consumer trends that may be of relevance and use in relation to future reward offerings.

1. A computer implemented method of effecting a merchant funded reward when a consumer purchases goods and/or services from a merchant using an electronic payment, comprising:
collecting, with a processor executing instruction code, transaction details of the consumer purchase;
processing, with a processor executing instruction code, the transaction details to calculate any associated reward; and
sending, with a processor executing instruction code, a notification of the entire reward to be collected from the merchant.

2. The computer implemented method according to claim 1 wherein part of the reward collected from the merchant is provided to the consumer.

3. The computer implemented method according to claim 1 wherein a consumer's line of credit is accessed to settle the transaction.

4. The computer implemented method according to claim 1 wherein a consumer's funds residing within an account are accessed to settle the transaction.

5. The computer implemented method according to claim 1 wherein the electronic payment is effected using on-line services including any one or more of the following:
(a) on-line service provided by a web-site;
(b) on-line service provided directly by a cell phone; and
(c) on-line services provided by portable electronic devices operable to communicate wirelessly with a cell phone network.

6. The computer implemented method according to claim 1 wherein collection of the transaction details of the consumer purchase is effected by an interface to an electronic payments network over which transactions relating to electronic payments for purchases are transmitted.

7. The computer implemented method according to claim 6 wherein the electronic payment network is an “open loop” network.

8. The computer method according to claim 6 wherein the electronic payment network is a “closed loop” network.

9. The computer implemented method according to claim 1 wherein merchants and consumers participating in the merchant funded reward arrangement have their respective details recorded in a database and transactions passing over an electronic payment network, used to collect and process transaction details, are compared with the recorded details of merchants and consumers in the database thus enabling purchase transactions relating to participating merchants and consumers to be identified and recorded.

10. The computer implemented method according to claim 9 wherein the recorded purchase transactions relating to participating merchants and consumers are recorded by an independent processing system.

11. The computer implemented method according to claim 10 wherein the independent processing system calculates and establishes the appropriate consumer reward according to pre-defined rules.

12. The computer implemented method according to claim 11 wherein the pre-defined rules include any one or more of the following parameters:
(a) The type of reward offered by the merchant;
(b) The amount of reward offered by the merchant;
(c) The time and date for which an offered reward is valid;
(d) The specific location of the merchant offering the reward; and
(e) Any other detail relevant to calculating a reward that is to be collected from the merchant.

13. The computer implemented method according to claim 1 wherein the reward offered by the merchant is a cash rebate wherein the method comprises collecting the appropriate amount of cash from the merchant offering the reward and depositing the cash collected from the merchant into the account of a consumer.

14. The computer implemented method according to claim 13 wherein the cash rebate collected from the merchant is deposited into a consumer's cash account and the consumer subsequently withdraws the cash rebate from their cash account.

15. The computer implemented method according to claim 1 comprising sending, with a processor executing instruction code, a notification to the consumer advising the consumer that a cash rebate has been deposited into a nominated cash account.

16. A system for effecting merchant funded rewards for purchases of goods and/or services from merchants offering rewards where the consumer effects an electronic payment, comprising:
an interface module operably connected to an Electronic Payments Network executing computer instruction code that causes the monitoring of purchase transactions;
a processing module executing computer instruction code that causes the identification of relevant monitored purchase transactions and calculating the rewards, if any, relevant to the transactions; and
a communication module executing computer instruction code that causes the transmission of details of the entire calculated reward to be collected from the merchant.

17. The system for effecting merchant funded rewards according to claim 16 wherein participating merchants and consumers in the merchant funded reward arrangement have relevant details recorded in a database and the system further comprises a processor executing computer instruction code that monitors purchase transactions and compares same with the details recorded in the database to identify relevant monitored purchase transactions for which rewards should be calculated.

18. The system for effecting merchant funded rewards according to claim 17 wherein rewards are calculated according to pre-defined rules stored in electronic memory.

19. The system for effecting merchant funded rewards according to claim 18 further comprising a receiving module executing computer instruction code that receives details of calculated rewards to be collected from the merchant and effects a transfer of funds from the merchant to an account belonging to the consumer.

20. The system for effecting merchant funded rewards according to claim 19 wherein the receiving module generates and transmits a notification message to the consumer advising the consumer of a deposit of funds into the consumer's account according with the reward offered by the merchant.

21. A non-transitory computer-readable storage media comprising modules having computer instruction code recorded thereon, the computer instruction code configured to execute the steps of effecting a merchant funded reward according to claim 1.
